(19) United States
(12) Patent Application Publication
(10) Pub. No.: US 2013/0290041 A1
(43) Pub. Date: Oct. 31, 2013

(54) RESERVATION SYSTEM FOR DISTRIBUTED MULTICHANNEL TRANSACTIONS

(71) Applicant: Mayra I. Harley, Oldsmar, FL (US)

(72) Inventor: Mayra I. Harley, Oldsmar, FL (US)

(21) Appl. No.: 13/532,006

(22) Filed: Jun. 25, 2012

Related U.S. Application Data
(60) Provisional application No. 61/501,119, filed on Jun. 24, 2011.

(51) Int. Cl. G06Q 10/02

(52) U.S. Cl. CPC G06Q 10/02
USPC 705/5

(57) ABSTRACT

A reservation system for distributed multichannel transactions comprises hardware and software including one or more servers on which a database, such as a relational database, is stored and accessed. A reservation utility is integrated into a company's website seamlessly such that access to the reservation utility by a customer of the company using an input device over a network puts into use the reservation system. The utility automatically accesses the reservation system, accessing the database for availability and pricing information, reporting reservation information to the company and updating inventory information in the database. The utility provides a plurality of services, which may be unrelated services and may be tailored to the particular customer including access, availability and price of such services.

### CROSS RELATED APPLICATIONS

This application claims the benefit of U.S. Provisional Appl. No. 61/501,119, filed Jun. 24, 2011, the entire disclosure and drawings of which is hereby incorporated by reference herein in its entirety.

### FIELD OF THE INVENTION

The field relates to multi-channel marketing and computer implementations applicable to multi-channel marketing.

### BACKGROUND

Multi-channel retailing is known that integrates online and brick and mortar retailing operations. Software for tracking multi-channel retailing is typically an in-house client-server relationship, where separate clients within a retail establishment access a server in order to avoid separate information technology channels for disparate retail channels. U.S. Publ. No. 2003/0004822 published Jan. 2, 2003 and framed the high overhead, reliable network environment and problems inherent in client-server IT solutions for multi-channel retailing. Instead, this publication suggested a peer network, sending data messages to each peer network and locally storing data on each network, which the reference teaches has advantages for speed of retrieval and highly reliable access to data compared to a client-server solution. U.S. Pat. Nos. 4,567,609, issued Jan. 28, 1986, and 6,754,369, issued Jun. 22, 2004, describe optical character recognition of vehicle license plates, and the written description and drawings of these issued patents are both incorporated herein by reference in their entirety for the purpose of introducing methods and devices for recognizing vehicle license plates.

Additional channels, such as call centers and the like, increase the complexity of multi-channel retailing IT solutions, and there is no multi-channel marketing solution suitable for a wide variety of businesses and their customers, particularly when real-time reservation systems are involved. Airline systems that aggregate fares are known, but these systems are notoriously poor at providing actual final price and availability information, until very near the end of a customer's booking of a flight. Only at this point are the prices and availability known. Even with advances is technology, airline reservation systems do not operate seamlessly on a businesses website as a utility that allows easy access to a plurality of services. To the extent that hotel and car reservations are combined, the effort at combination is inadequate and requires booking with one of a large number of hotels and separate car rental companies. Furthermore, the database for the car rental company reservation, the airline reservation and the hotel reservation are all maintained in separate, proprietary databases maintained by the airline, car rental agency and/or hotel or hotel system. Therefore, known systems do not provide seamless operation of distributed multichannel transactions and do not provide for reservations for a plurality of different services on a business website as a utility.

### SUMMARY

For example, a multi-channel system for marketing, including retail marketing or business to business marketing, provides a seamless integration with a company's website, such that access to a utility on the website updates a database coupled to the server or computer system hosing the website over a network, such as the Internet. As a result one or more servers may be used for accessing and storing information to the database, such as a relational database. In one example, the system is a reservation system comprising a network, one or more servers coupled to the network, the servers operating software for managing a reservation system distributed across the one or more services, electronically over the network, for the reservation of a plurality of different services. The plurality of services may be reserved for specific dates or times using a single reservation utility for a plurality of unrelated or related services. For example, the reservation system provides a reservation utility. A business computer system may be coupled to the network, such as the Internet. The business computer may be hosting a website accessible over the network. The reservation utility of the reservation system may be hosted on one or more servers, other than the business computer, for example. In one example, the reservation is a utility, such as a Java applet, html code or the like. The reservation utility is integrated on the website hosted by the business computer, such that data entered on the website by a data entry device, which may be connected to the computer hosting the website by the network, may be captured by the servers. The database on the servers then reserves one or more of the plurality of different services for the specific dates or times booked by the data entered over the network via the website.

In this example, the system is neither a client-server architecture nor a peer network. Instead, the utility accessible through the website appears to the user to be a part of the website hosted by the business computer. Instead, a customer, a customer service representative or an agent at a retail location may enter data into the utility using any data entry device capable of entering data in the utility, and the utility automatically updates data entries in the database hosted on one or more servers. Likewise, the information on availability and price displayed in the utility may be updated and accurate, because the data displayed in the utility is data obtained from the database. In one example, the data presented depends on the identity of the customer. Therefore, each customer or a group of customers may have different rates presented based on information stored in the database. Each of a plurality of servers may be separate from the business computer system. The reservation utility of the reservation system may be integrated within the website hosted by the business computer system, for example.

When the reservation utility of the reservation system is accessed by a customer of a business operating the business computer system for reserving one or more of the plurality of different services for specific dates or times, the reservation system automatically schedules the one or more of the plurality of different services for specific dates or times and automatically updates the availability of the one or more of the plurality of different services within the database, for example. When the customer puts the system into use, the customer may be unaware that the reservation utility is interacting with any servers. Instead, the customer experiences a seamless interaction with a website without any need to understand or appreciate that the utility functions over the network with a database stored on one or more servers, which may be distributed on the network.

In another example, the business may access the reservation system for management of a plurality of different services offered by the business. For example, the business may access the management system over the network by accessing a particular web portal. Alternatively, the business may access a utility on its own website seamlessly integrating the website with the database stored on one or more remote, distributed servers. In one example, a business accesses the reservation system for management of the plurality of different services using a reservation management utility provided on a reservation management website for the business.

For example, a plurality of different services may include parking services, detailing services and transportation services, and a reservation utility may present options for scheduling of the detailing services and transportation services in conjunction with the parking services within the same reservation utility.

### BRIEF DESCRIPTION OF THE DRAWINGS

FIG. 1 illustrates a flow diagram of one example.

FIG. 2 illustrates a relational diagram showing industries and companies providing one or more channels for customers.

FIG. 3 illustrates a hierarchical diagram of one example of an omni-channel reservation and retail system.

FIG. 4 illustrates a utility integrated on a company website.

FIG. 5 illustrates one example of a multi-channel reservation system for a plurality of services offered seamlessly with a website coupled with a database stored on one or more services over a network.

FIG. 6 illustrates an email receipt, which may be automatically generated by the reservation system or may be requested by an end user, at any time by seamlessly accessing the company website.

FIG. 7 illustrates an example of an email receipt.

FIGS. 8-10 illustrate examples of reports.

FIG. 11 illustrates an example of data fields/classes.

### DETAILED DESCRIPTION

A computer system may be connected to a network and may include programming and data stored on a storage device, implementing a system for reservation management, comprising a multichannel network connection capable of connecting to a plurality of distributed clients for arranging reservations using the computer system, programming, and data stored on a storage device, the programming providing the following technical solutions when implemented by execution using computer processor.

A system for distributed, multichannel distribution may be implemented on a computer, such as a server, using software, when coupled with a database stored on an accessible storage medium. The system provides the following technical solutions. Consumers may use more than one “channel” (web, catalog, mobile, store) to make a purchase or reservation on a website that utilizes a utility operatively interfaced over a network with one or more servers, wherein the customer need not be aware that a plurality of services are being provided using more than one channel.

One example has the ability to allocate inventory at a more granular level to better respond to consumer demands across all selling channels. It also has the ability to assign great importance to inventory visibility across all channels. Consumers may use the digital “channels” to make a transactional decision even if it is ultimately completed in a retail establishment. One example includes web-based software that is an interchangeable, unit-based inventory management system featuring sophisticated pricing, multi-channel management. For example, forecasting capabilities may be built around a store-centric demand model.

Examples of industries capable of benefitting are described as follows:

Conference and Meeting Facilities
✓ Meeting/Banquet
✓ Convention Bureaus
✓ Chamber of Commerce
Equipment Rental
✓ Audio/visual Equipment
✓ Construction Equipment
✓ Electronics
✓ Event Equipment
Health
✓ Gym & Personal Trainers
✓ Massage Therapy
✓ Spa
✓ Yoga Studios
Home Services
✓ Cleaning Services
✓ Nanny Services
✓ Boarding/Kennels
Lodging
✓ Bed & Breakfast Inns
✓ Campgrounds
✓ Log Cabins
✓ Resorts
✓ Vacation Rentals
Recreation & Sports
✓ Bicycle Rentals
✓ Boat Rentals
✓ Golf
✓ Horseback Riding
✓ Rafting
✓ Scuba Diving
✓ Skydiving
✓ Sports Fishing
✓ Wind Surfing/Kite Surfing/Surfing
✓ Yacht Charters
Travel & Tours
✓ City Tours
✓ Guided Tours
✓ Nature Tours
✓ Off-Road Adventures
✓ Segway Tours
✓ Vacation Seminar
Transportation
✓ ATV Rentals
✓ Air Charters
✓ Aircraft Rental
✓ Car/Truck Rentals
✓ Limousine Services
✓ Motorcycles
✓ Parking
✓ Scooter and Wheelchair
✓ Shuttle Services
Warehousing
✓ Self Storage

A method for improving performance of a distribution order system may be used for multi-channel management. Consumers orders generated from the web, mobile, and retail channels are provided enterprise-wide visibility into the company's inventory. For example systems may comprise third-party systems integration (point of sale, internet distribution systems, property management system, etc), highly configurable system to accommodate any business operation (simple or complex rate structures, multiple languages, etc), white label (“branded”) online booking engine for both company and facility level, multi-channel management tools and a dynamic packaging component to sell additional services and products over multiple channels.

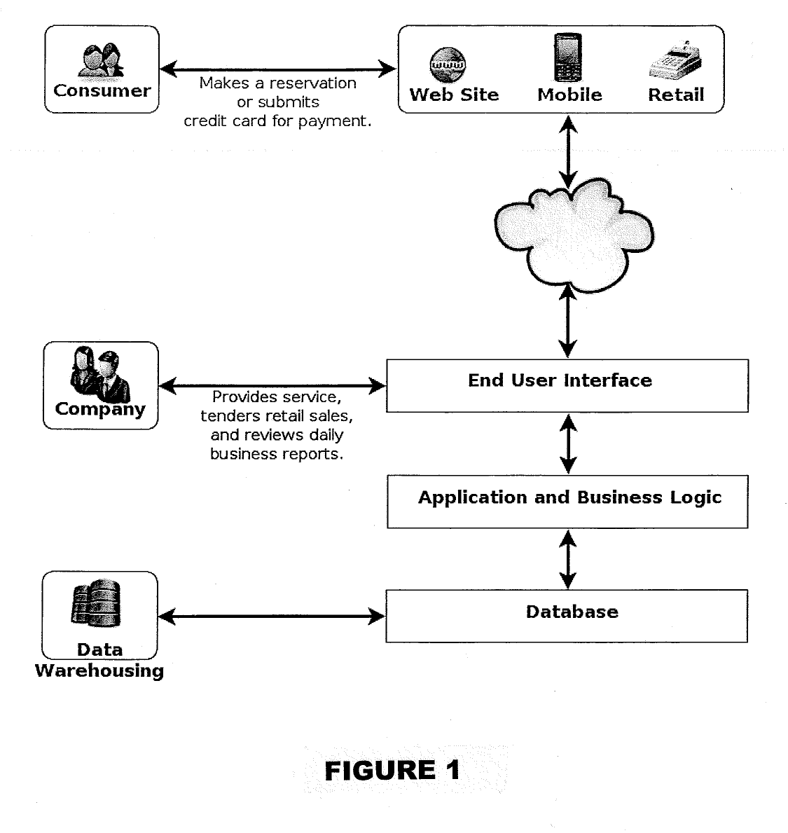

For example, companies may think holistically about their business integrating store-level fulfillment with omni-channel selling capabilities and omni-channel customer order generation capabilities. Unlike shopping aggregators and price comparison sites, an omni-channel management offers price transparency within the companies' own “walls”. The invention enables the company to be a part of the omni-channel model enabling a “buy anywhere, get anywhere” strategy. In one example, a system uses a relational database architecture and object oriented design for data abstraction, messaging, modularity, and polymorphism. Logical data modeling may define the business entities and their relationships in order to provide a holistic view of the data for processing and reporting, such as illustrated in the process flow diagram in FIG. 1. For example, retailers with cross-channel activities may offer consumers a “buy anywhere” model and fulfill through a “best inventory” source, using “distributed order management.”

As an example of an Interchangeable Transaction Engine and an Omni-channel Management system, one example operates as follows. The system comprises a database comprised of multiple companies' information on their products and services organized as a single database on a server or servers connected by a network. The system stores data to identify unlimited unit types (i.e., products and services) inventory and rates for each company. The system stores data to identify all distribution channels (i.e., in-store, on-line, mobile) for each company. The system stores inventory and rate data for unlimited products and services as well as business rules for qualifying availability. The system is coupled with a user interface for advance reservations and order placement in addition reports. The system is coupled with a user interface for data retrieval and reports. The system is coupled with a user interface for point of sale and reports. A reservation system receives requests for reservations/inventory and rate data for unlimited products and services from multiple distribution channels identified within the system database. A point-of-sale system receives requests for inventory and rate data for unlimited products and services from multiple distribution channels identified in the system and receives the reservation and order requests and stores the reservation and order data in the database. A user interface receives reservation and order data and provides access to the reservation and order request to the user. The system updates the inventory and rates data and updates the database with the reservation and order details in response to the reservation and order request. The inventory and rate data update is generated in real time as each reservation and order is completed to reflect current inventory regardless of the source of the inventory and rate data update and presents updated inventory and rate data to the reservation system interface and point of sale interface. For example, a customer may have a utility installed for reserving a plurality of services on the customer's website, and use of the utility automatically updates the database accessed by the businesses providing the plurality of services. The system monitors and stores each set of inventory and rate update and sequence number data associated with reservations and orders and updates a central database to decrease the number of available units for the channel. The inventory data may include unit-based availability data for each of the available units at each channel managed, and where the inventory update data includes reservation and order for a respective unit at one of the channels that reflects units that were previously indicated as being available at that channel and which have since become unavailable. A system includes a company-wide system receiving company modification data and updating the database with the company modified data. The system is comprised of a point-of-sale system receiving retail modification data and updating the database with the retail modified data. The system includes a price tracking and management system which receives rate plan modification data and updates the database with the rate plan modification data. In one example, different customers may receive different rates for booking the same service, at the same time, depending on the rate schedule set, or a differential set, for the particular customer. The system may have a distribution channel management system receiving distribution channel modification data and updating the database with the distribution channel modified data. The system stores reservation data reflecting the current status of available inventory from each distribution channel in the relational database, for example, and may receive status update data at a local point-of-sale system when a unit has been consumed and transmits the status update data to a central database to change the inventory for each of the channels where that unit is available.

In one example, a system stores reservation data reflecting the current status of rate plan data from each distribution channel in a database, receives status update data at a local point-of-sale system when a rate plan at the property has been changed and transmits the status update data to a central database to change the rate plan for each of the channels where that unit is available. The system stores reservation data reflecting the current status of company data from each company in a database, receives status update data at a local point-of-sale system when distribution channel data for a company has been changed; transmits the status update data to a central database to change the distribution channel data for each distribution channel.

The system's capabilities and technology may be used to increase service levels to consumers and position the right inventory in the right place at the right time, for example. The system may have has the ability to manage more complex assortments and perpetual inventory at the enterprise level. One view of demand and one view of inventory enable the ability to allocate inventory at a more granular level across all the selling channels. It is clear that there is no “silver bullet” for managing extremely fast or slow moving items; however, better visibility and accuracy is key. The invention may provide the ability to see digital assets such as a customer's history and purchase activity, as well as physical assets like inventory across all the available channels whether they are store, web, customer call center, mobile, or a shopping web site.

In one example, a consumer has misplaced their computer's power cord and goes to a big box store to buy a replacement. This particular retail company offers receipt via email as their commitment to be a “green” organization. The clerk assures the consumer that they can return the product without any problem if the missing cord is recovered, so long as they have their receipt. When the missing cord is found, the consumer finds that there is no email receipt, and the customer calls an 800-number for customer service. Access to the store receipt files is provided by the system, and the representative re-sends the email to the address on file. The customer service associate asks the customer to check and confirm safe receipt. The relational database accessed has all of the information about the customer and the sales in whatever channels applicable. Alternatively, using the same system, a customer may have created a profile using a utility on the company's website, and the profile would enable the customer to retrieve and reprint a lost receipt via the company's website, using the utility, because the utility on the website seamlessly communicates with the database on one or more of services connected by a network to the server hosting the company's website, even if neither of the servers are owned by the company.

In the flow chart of FIG. 1, a consumer makes a reservation such as by submitting a credit card for payment or entering a user id and password or the like. In making the reservation, the customer uses and input device, such as a mouse, keyboard and computer display or voice commands or by accessing a call center or using any other channel. In the example of accessing a website or a mobile application, the customer may be unaware that the customer may be accessing a third party database stored on one or more servers, such as on the cloud. The transaction is transparent to the customer. The system accesses a database, which may be stored anywhere on an accessible network. The end user interface provides the same access to the system regardless of the channel used to access the end user interface, for example. The company may access an end user interface, also, which may allow the company to provide services, make sales and review and generate reports. Software application and business logic provides middleware between the seamless user interface and a database, such as a relational database, for example. The database may be stored on one or more servers, which may be coupled together by a network, for example.

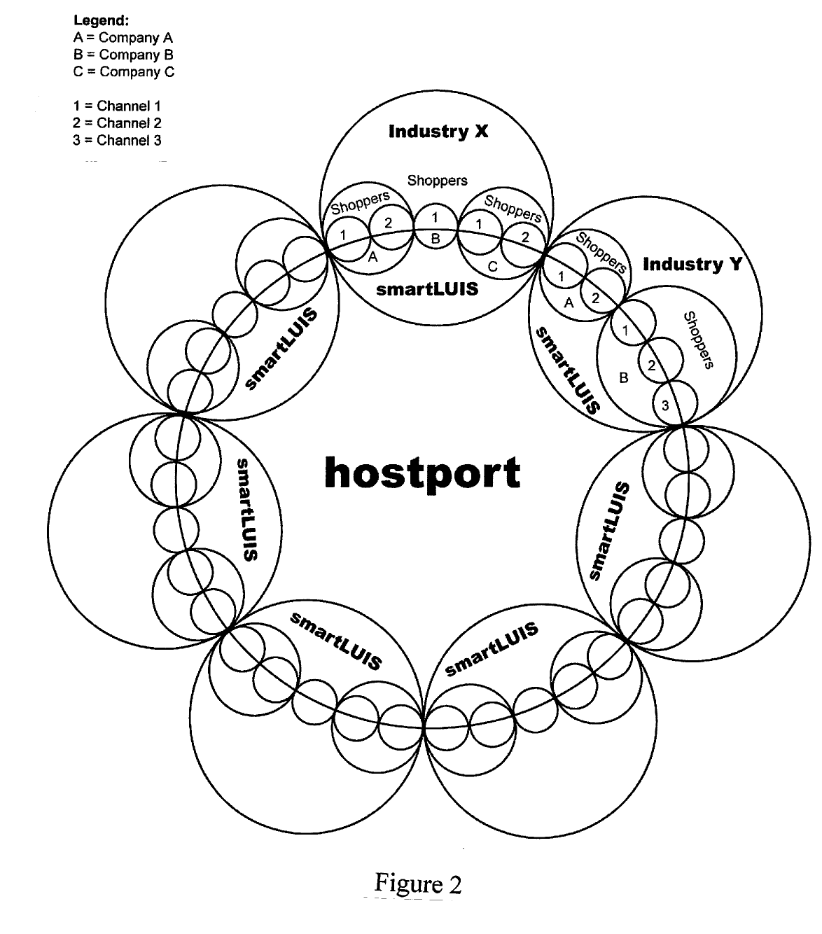

The example illustrated in FIG. 2 represents a diagram showing a plurality of companies in a variety of industries cooperatively providing a plurality of services over a common system with seamlessly integrated and uniquely tailored products and services delivered to their customers on their own individual websites, for example. In one example, a plurality of companies may provide services to customers in a particular industry. Alternatively, one company may target one set of customers and a different company may target a different set of customers, even within the same industry. Regardless, a multi-channel access may be provided by the system, seamlessly.

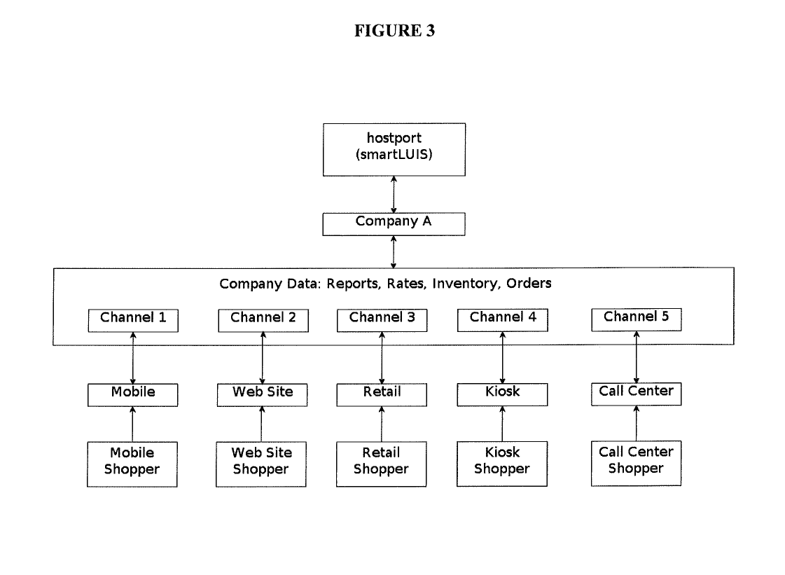

FIG. 3 illustrates a hierarchical view of the hostport referred to as smartLUIS that supports, in this example, Company A, utilizing five channels, e.g. mobile, website, retail, kiosk and call center channels. In this case, the same interface may be provided seamlessly for each such channel.

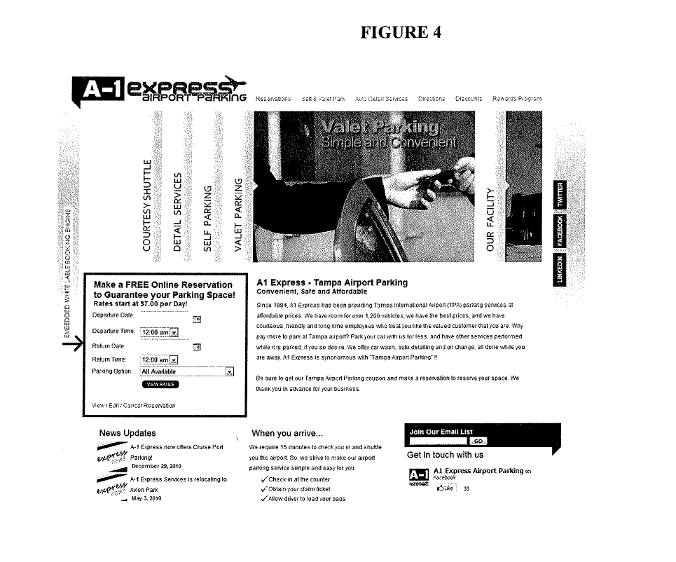

FIG. 4 illustrates one example of an online reservation system utility seamlessly integrated on the website of A-1 express, a company that provides courtesy shuttle, detailing, self parking and valet parking services to customers in multiple channels. In one example, an automated character recognition system determines the characters on a license plate as a vehicle approaches, and the reservation system automatically matches the license plate with a reservation for the same vehicle license plate. For example, check in at the facility may be expedited or automated. In one example, the reservation system may notify the company if the customer is running late and may expedite transportation to the customer's next destination.

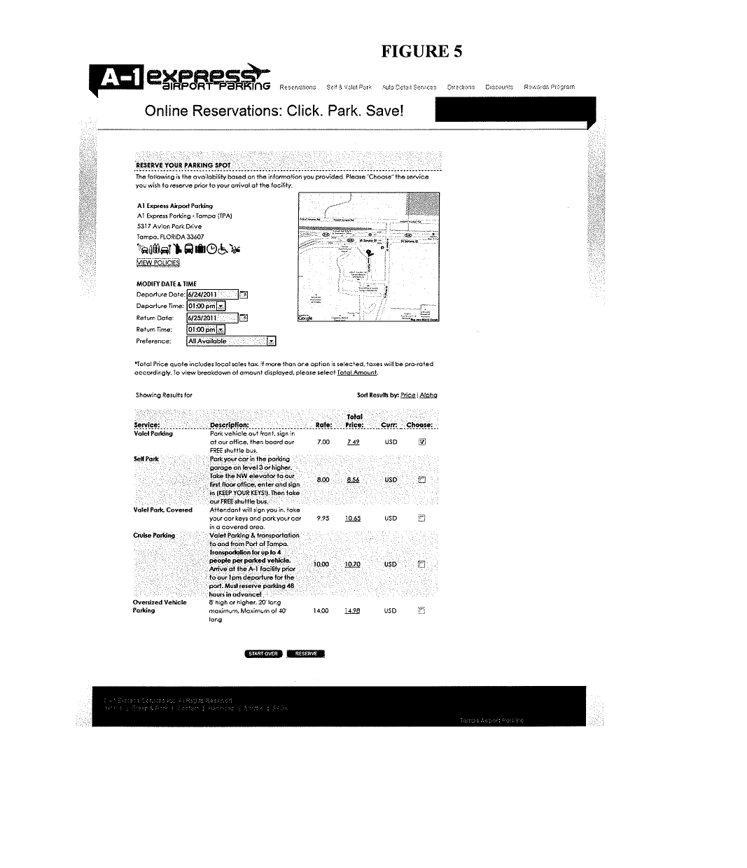

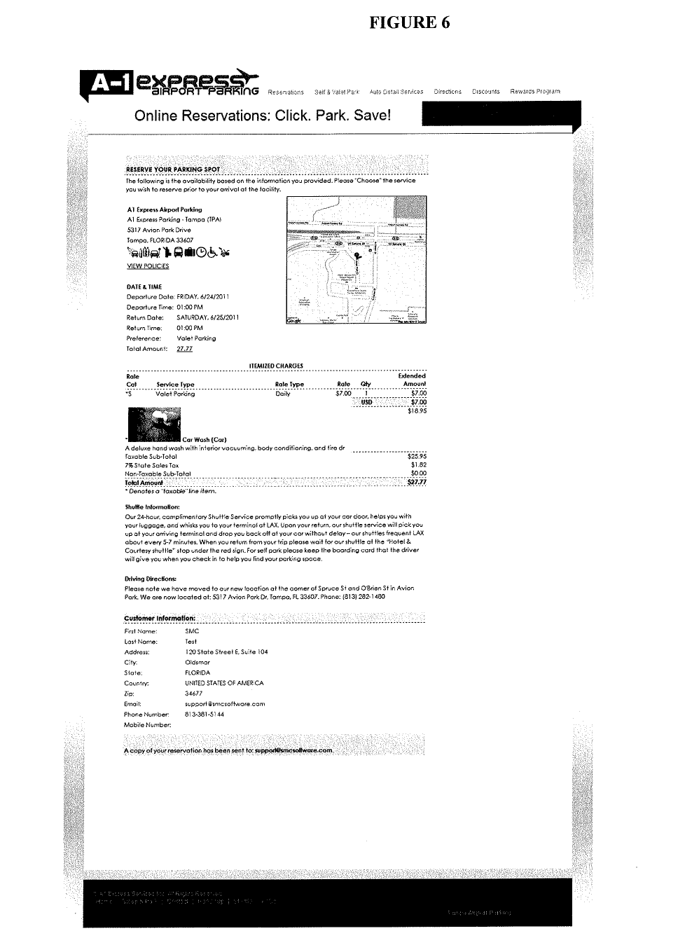

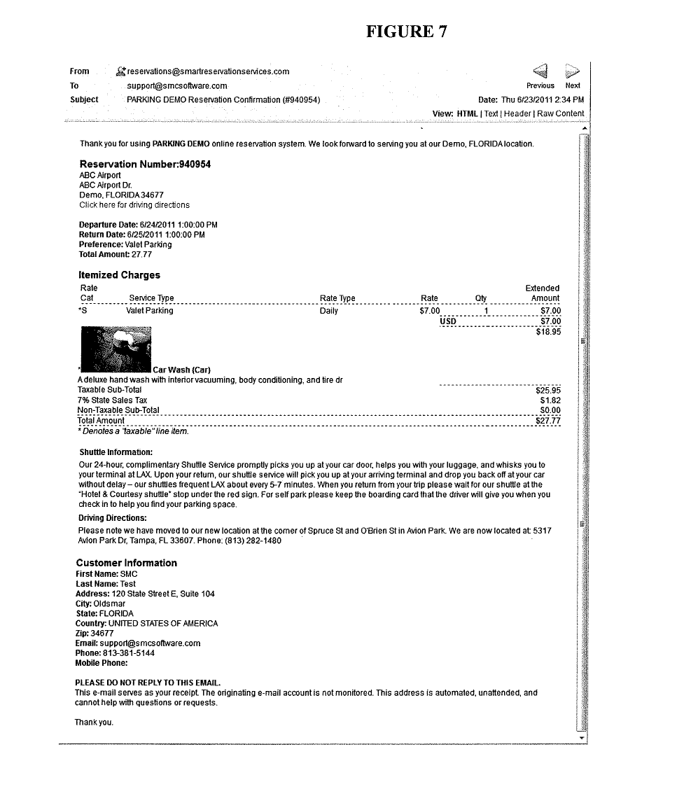

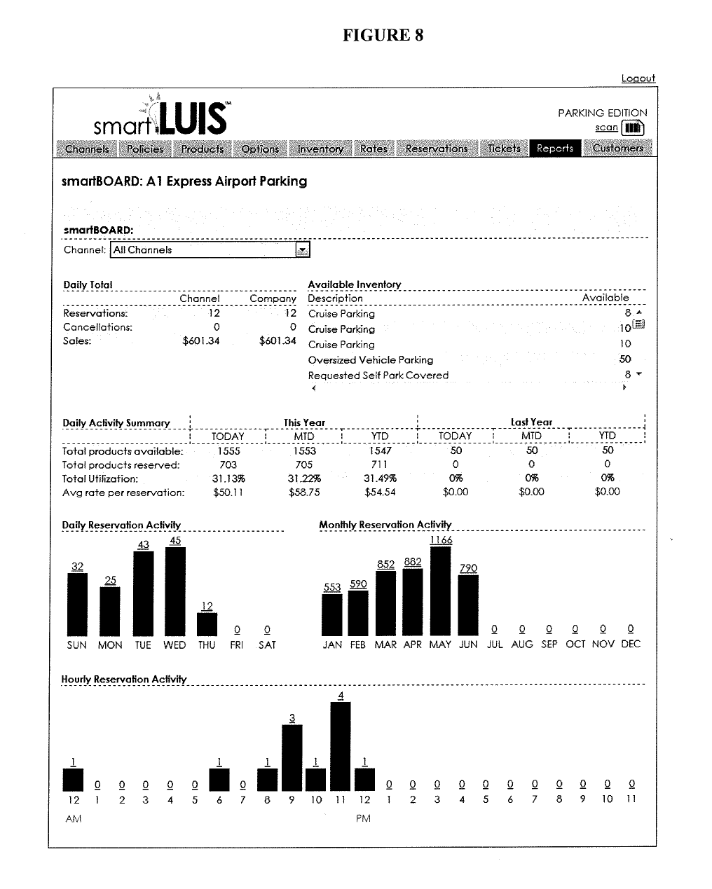

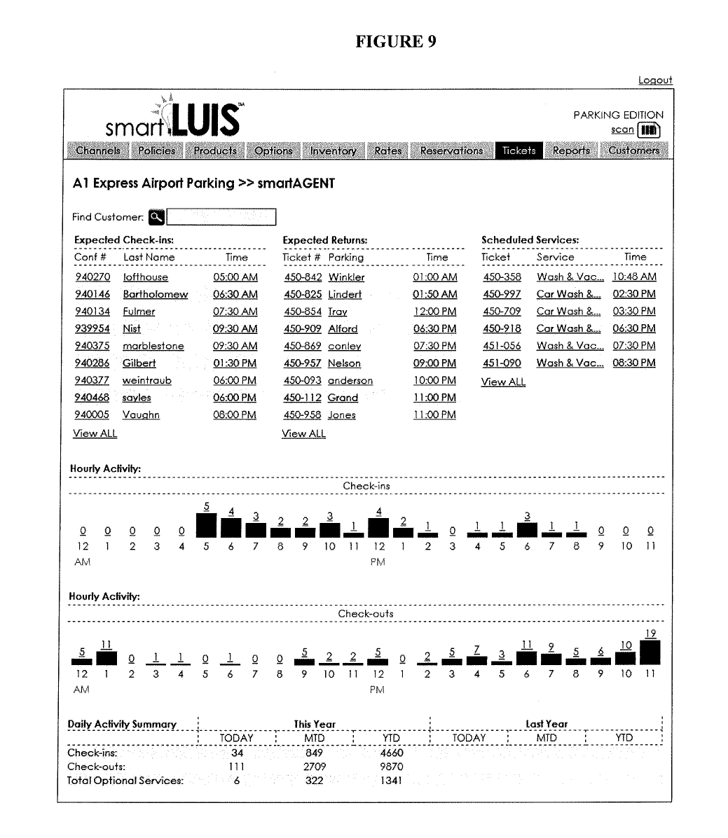

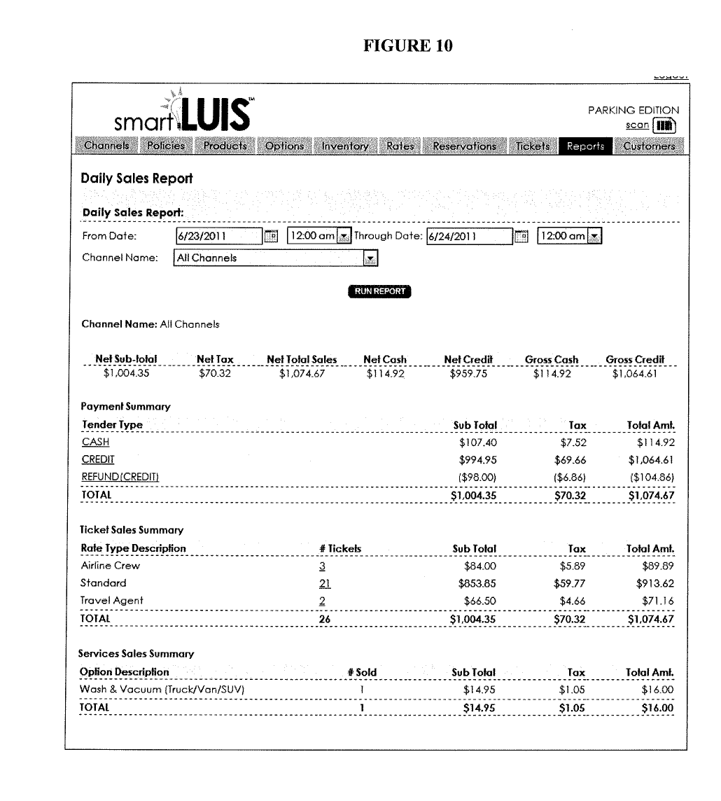

FIG. 5 illustrates a reservation in process using the utility, which directly accesses data in the database to show the services available, the availability of dates and times and the rates available to this customer. FIG. 6 illustrates a completed reservation and a report provided to the customer, which completion generates an email based on end user preferences, also. An example of an email receipt is shown in FIG. 7. FIG. 8 illustrates a report generated for the company, A1 Express Airport Parking, for example. FIG. 9 illustrates the tickets generated for this company. FIG. 10 illustrates a daily sales report, for example.

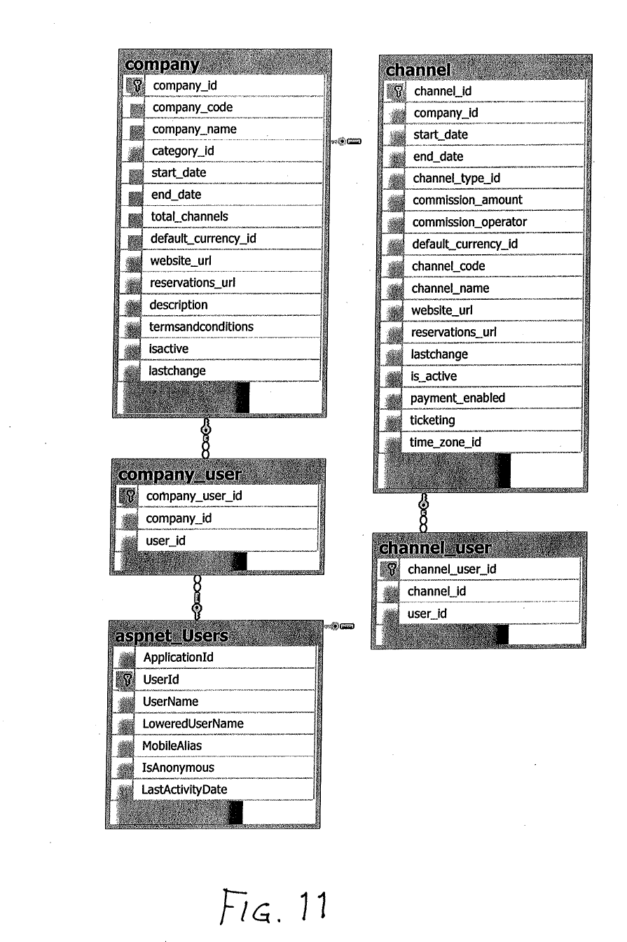

In the example of FIG. 11, some fields in a relational database are illustrated. Combining the database structure example with example source code in Appendix A, for example, a utility for a reservation system may be integrated on any website for reserving services, such as parking or self-parking, detailing and transporting customers.

### APPENDIX A

### Copyright 2011 SMC All Right Reserved

### Example Source Code Excerpts Listing:

User Assembly (Company and Channel ACLs added to UserContext Object):

```
  public static UserContext BuildUserContext(System.Security.Principal.IPrincipal usr, Guid
useridentifier)
  {
    string usertype = GetWebUserType(useridentifier);
    MembershipUser user = Membership.GetUser(useridentifier);
    if (user != null)
    {
      if (usertype == “HOSTPORT” || usertype == “LUIS”)
      {
        HttpCookie authcookie = FormsAuthentication.GetAuthCookie(user.UserName, false);
        if (authcookie != null)
        {
          FormsAuthenticationTicket newTicket =
FormsAuthentication.Decrypt(authcookie.Value);
          if (newTicket.Name != usr.Identity.Name)
          {
            FormsAuthentication.SignOut( );
            HttpContext.Current.Server.Transfer(“~/Authentication/Login.aspx”);
          }
        }
        else
        {
          FormsAuthentication.SignOut( );
        HttpContext.Current.Server.Transfer(“~/Authentication/Login.aspx”);
      }
    }
    }
    else
      {
      FormsAuthentication.SignOut( );
      HttpContext.Current.Server.Transfer(“~/Authentication/Login.aspx”);
    }
    UserContext context = new UserContext(user.UserName, (Guid)user.ProviderUserKey);
    ConfigurationObjectsCollection config = new ConfigurationObjectsCollection( );
    FormsAuthenticationTicket AuthTicket = new FormsAuthenticationTicket(user.UserName,
true, Convert.ToInt32(ConfigurationManager.AppSettings[“FormsAuthCookieTimeOut”]));
//should be same as cookie expiration
    FormsIdentity NewFormsIdentity = new FormsIdentity(new
FormsAuthenticationTicket(AuthTicket.Version, user.UserName, AuthTicket.IssueDate,
AuthTicket.Expiration, AuthTicket.IsPersistent, AuthTicket.UserData));
    string[ ] Roles = AuthTicket.UserData.Split(“|”.ToCharArray( ));
    System.Security.Principal.GenericPrincipal NewGenericPrincipal = new
System.Security.Principal.GenericPrincipal(NewFormsIdentity, Roles);
    context.HostPortAdmin = IsHostPortRole(NewGenericPrincipal.Identity);
    context.Ticketing = IsTicketingRole(NewGenericPrincipal.Identity);
    context.Roles = System.Web.Security.Roles.GetRolesForUser(user.UserName);
    if (!context.HostPortAdmin)
    {
      context.DefaultCompanyId = ApplicationLibrary.GetCompanyId(context,
GetConnectionString( ));
    }
    ArrayList companyids = ApplicationLibrary.GetUserCompanyIds(context,
GetConnectionString( ));
    ArrayList channelids = ApplicationLibrary.GetUserChannelIds(context,
GetConnectionString( ));
    context.Companies = new CompanyObjectsCollection( );
    context.Channels = new ChannelObjectsCollection( );
    foreach (object companyid in companyids)
    {
      if (!context.Companies.Contains(Convert.ToInt64(companyid)))
        context.Companies.Add(ApplicationLibrary.GetCompany(context,
Convert.ToInt64(companyid), GetConnectionString( ));
    }
    if (channelids.Count > 0)
    {
      foreach (object channelid in channelids)
      {
        if (!context.Channels.Contains(Convert.ToInt64(channelid)))
          context.Channels.Add(ApplicationLibrary.GetChannel(Convert.ToInt64(channelid),
GetConnectionString( ));
      }
    }
    foreach (PropertyInfo pi in user.GetType( ).GetProperties( ))
    {
      config.Add(new ConfigurationObject(pi.Name, pi.GetValue(user, null)));
    }
    config.Add(new ConfigurationObject(“ConnectionString”, GetConnectionString( )));
    context.Configuration = config;
    context = PopulateThemeInfo(context);
    string encryptedTicket = FormsAuthentication.Encrypt(AuthTicket);
    HttpCookie authCookie = new
HttpCookie(FormsAuthentication.FormsCookieName+“_WEBUSER”, encryptedTicket);
    authCookie.Expires =
DateTime.Now.AddMinutes(Convert.ToDouble(ConfigurationManager.AppSettings[“FormsAuth
CookieTimeOut”]));//make sure its same as the formsauthentication ticket expiry value
    HttpContext.Current.Response.Cookies.Add(authCookie);
    return context;
  }
  public static UserContext BuildUserContext(System.Security.Principal.IPrincipal usr,
System.Web.UI.Page page)
  {
    if (string.IsNullOrEmpty(usr.Identity.Name))
    {
      FormsAuthentication.SignOut( );
      page.Server.Transfer(“~/Authentication/Login.aspx”);
    }
    else
    {
      MembershipUser user = Membership.GetUser(usr.Identity.Name);
      UserContext context = new UserContext(user.UserName, (Guid)user.ProviderUserKey);
      ConfigurationObjectsCollection config = new ConfigurationObjectsCollection( );
      context.HostPortAdmin = IsHostPortRole(usr.Identity);
      context.Ticketing = IsTicketingRole(usr.Identity);
      context.Roles = System.Web.Security.Roles.GetRolesForUser(user.UserName);
      if (!context.HostPortAdmin)
      {
        context.DefaultCompanyId = ApplicationLibrary.GetCompanyId(context,
GetConnectionString( ));
      }
      ArrayList companyids = ApplicationLibrary.GetUserCompanyIds(context,
GetConnectionString( ));
      ArrayList channelids = ApplicationLibrary.GetUserChannelIds(context,
GetConnectionString( ));
      context.Companies = new CompanyObjectsCollection( );
      context.Channels = new ChannelObjectsCollection( );
      foreach (object companyid in companyids)
      {
        if (!context.Companies.Contains(Convert.ToInt64(companyid)))
          context.Companies.Add(ApplicationLibrary.GetCompany(context,
Convert.ToInt64(companyid), GetConnectionString( )));
      }
      if (channelids.Count > 0)
      {
        foreach (object channelid in channelids)
        {
          if (!context.Channels.Contains(Convert.ToInt64(channelid)))
context.Channels.Add(ApplicationLibrary.GetChannel(Convert.ToInt64(channelid),
GetConnectionString( )));
        }
      }
      foreach (PropertyInfo pi in user.GetType( ).GetProperties( ))
      {
        config.Add(new ConfigurationObject(pi.Name, pi.GetValue(user, null)));
      }
      config.Add(new ConfigurationObject(“ConnectionString”, GetConnectionString( ));
      context.Configuration = config;
      context = PopulateThemeInfo(context);
      return context;
    }
    return new UserContext( );
  }
```

### Control Binding:

Presentation Layer:

```
  private void setControls( )
  {
    channels = ApplicationLibrary.GetAllChannels(context, companyid,
Helpers.GetConnectionString( ));
    this.DropDownListChannels.DataSource = channels;
    this.DropDownListChannels.DataTextField = “channel_name”;
    this.DropDownListChannels.DataValueField = “channel_id”;
    this.DropDownListChannels.DataBind( );
  }
```

Application Layer:

```
  public static DataSet GetAllChannels(UserContext context, long
companyid, string connectionstring)
  {
      return ChannelData.GetAllChannels(context, companyid,
      connectionstring);
  }
```

Data Layer:

```
  private const string GET_CHANNELS_SP = “LUIS_GetChannelsForUser”;
  public static DataSet GetAllChannels(UserContext context, long companyid, string
connectionstring)
  {
      SqlConnection conn = SqlHelpers.GetConnection(connectionstring);
      SqlCommand command = new SqlCommand(GET_CHANNELS_SP, conn);
      command.CommandType = CommandType.StoredProcedure;
      command.Parameters.Add(“@user_id”, SqlDbType.UniqueIdentifier).Value = context.Id;
      command.Parameters.Add(“@company_id”, SqlDbType.BigInt).Value = companyid;
      conn.Open( );
      DataSet ds = new DataSet( );
      try
      {
        SqlDataAdapter adapter = new SqlDataAdapter(command);
        adapter.Fill(ds, “Channels”);
        adapter.Dispose( );
      }
      catch (Exception ex)
      {
        throw ex;
      }
      finally
      {
        conn.Close( );
      }
      return ds;
  }
  TSQL (Stored Procedure)
  ------------------------------------
  ALTER PROCEDURE [dbo].[LUIS_GetChannelsForUser]
      @user_id uniqueidentifier,
      @company_id bigint
  AS
  BEGIN
      SET NOCOUNT ON;
      DECLARE @UserChannelIds TABLE (channel_id bigint)
      INSERT INTO @UserChannelIds (channel_id) EXEC LUIS_GetUserChannelIds
@user_id
      SELECT co.company_id, ch.channel_id, ch.[start_date], ch.end_date,
ch.channel_type_id, ct.channel_type_code, ct.channel_type_description,
ch.commission_amount, ch.commission_operator, ch.default_currency_id, ch.channel_code,
ch.channel_name, cu.currency_code, cu.currency_description, ch.website_url,
ch.reservations_url, ch.lastchange, ch.is_active, ch.payment_enabled, ch.time_zone_id
      FROM channel ch WITH(NOLOCK)
          INNER JOIN company co on ch.company_id = co.company_id
          INNER JOIN company_user cou on ch.company_id = cou.company_id
          INNER JOIN channel_type ct on ch.channel_type_id = ct.channel_type_id
          INNER JOIN currency cu on ch.default_currency_id = cu.currency_id
      WHERE co.company_id = @company_id
      AND cou.user_id = @user_id
      AND ch.channel_id IN (SELECT channel_id FROM @UserChannelIds)
  END
```

What is claimed is:

1. A reservation system integrating hardware and software, comprising:
a network;
one or more servers coupled to the network, the servers operating software for managing a reservation system distributed across the one or more services, electronically over the network, for the reservation of a plurality of different services for specific dates or times, the reservation system providing a reservation utility;
a business computer system coupled to the network and hosting a website on the network, wherein the reservation utility of the reservation system is hosted on one or more of the servers and is integrated on the website such that data entered on the website by a data entry device is captured by the servers and reserves one or more of the plurality of different services for specific dates or times; and
wherein the servers are separate from the business computer system, and the reservation utility of the reservation system is integrated within the website hosted by the business computer system.

2. The reservation system of claim 1, wherein, when the reservation utility of the reservation system is accessed by a customer of a business operating the business computer system for reserving one or more of the plurality of different services for specific dates or times, the reservation system automatically schedules the one or more of the plurality of different services for specific dates or times and automatically updates the availability of the one or more of the plurality of different services.

3. The reservation system of claim 2, wherein when the customer puts the system into use, the customer is unaware that the reservation utility is interacting with the servers, and the customer experiences a seamless interaction with the website.

4. The reservation system of claim 1, wherein the business accesses the reservation system for management of the plurality of different services.

5. The reservation system of claim 4, wherein the business accesses the reservation system for management of the plurality of different services using a reservation management utility provided on a reservation management website for the business.

6. The reservation system of claim 5, wherein, when the reservation utility of the reservation system is accessed by a customer of a business operating the business computer system for reserving one or more of the plurality of different services for specific dates or times, the reservation system automatically schedules the one or more of the plurality of different services for specific dates or times and automatically updates the availability of the one or more of the plurality of different services.

7. The reservation system of claim 6, wherein when the customer puts the system into use, the customer is unaware that the reservation utility is interacting with the servers, and the customer experiences a seamless interaction with the website.

8. The reservation system of claim 7, wherein the plurality of different services include parking services, detailing services and transportation services, and the reservation utility presents options for scheduling the detailing services and transportation services in conjunction with the parking services within the same reservation utility.

9. The reservation system of claim 6, wherein the plurality of different services include parking services, detailing services and transportation services, and the reservation utility presents options for scheduling the detailing services and transportation services in conjunction with the parking services within the same reservation utility for reserving the parking services.

10. The reservation system of claim 5, wherein the plurality of different services include parking services, detailing services and transportation services, and the reservation utility presents options for scheduling the detailing services and transportation services in conjunction with the parking services within the same reservation utility for reserving the parking services.

11. The reservation system of claim 4, wherein the plurality of different services include parking services, detailing services and transportation services, and the reservation utility presents options for scheduling the detailing services and transportation services in conjunction with the parking services within the same reservation utility for reserving the parking services.

12. A process for using the reservation system of claim 4, comprising:
accessing by an end user a company website using a computer system;
utilizing the reservation utility embedded on the company website by entering a date or time for reserving at least one service of the plurality of different services;
advancing from the reservation utility to view rates or availability of services not previously displayed on the reservation utility embedded on the company website; and
requesting one or more of the plurality of different services, such that data entered on the website by the data entry device of the customer is updated on the servers via the network and one or more of the plurality of different services is reserved for specific dates or times.

13. The process of claim 12, further comprising reserving the specific dates or times for the one or more of the plurality of different services requested in the step of requesting.

14. The process of claim 12, further comprising recording the arrival of the customer when the customer arrives.

15. The process of claim 14, further comprising recording the departure of the customer when the customer departs and updating the inventory in the database stored in the servers.

16. The process of claim 14, wherein the step of recording the arrival is automated and includes automatically recognizing the characters on the license plate of the customer's vehicle, if available in the database, and adding the characters of the license plate in the database, if the characters of the license plate are unavailable or different in the database.

17. The process of claim 15, wherein the step of recording the arrival and the step of recording the departure are automated and includes automatically recognizing the characters on the license plate of the customer's vehicle, if available in the database, and adding the characters of the license plate in the database, if the characters of the license plate are unavailable or different in the database.
